(19) United States
(12) Patent Application Publication
(10) Pub. No.: US 2019/0090306 A1
(43) Pub. Date: Mar. 21, 2019

(54) WIRELESS NETWORK MANAGEMENT METHOD USING DYNAMIC PROXY

(71) Applicant: FITIVISION TECHNOLOGY INC., New Taipei City (TW)

(72) Inventor: Hsiang-Min Lee, New Taipei City (TW)

(21) Appl. No.: 15/709,480

(22) Filed: Sep. 20, 2017

(51) Int. Cl. H04W 88/04; H04L 29/06

(52) U.S. Cl. CPC H04W 88/04; H04W 12/04; H04L 63/0428; H04L 63/061

(57) ABSTRACT

This method uses first and second access devices to record configuration data of electronic devices, a weight calculation module to determine a priority index for each electronic device based on its usage status, a proxy designation module to compare the priority indices and designate an electronic device having the highest priority index as a proxy. Therefore, by sharing configuration data and evaluating priorities, one of the electronic devices also functions as the proxy to automatically manage data flow between the electronic devices, avoiding the use of externally added dedicated management devices. The exchanged data may be encrypted by an encryption unit.

### BACKGROUND OF THE INVENTION

### (a) Technical Field of the Invention

The present invention generally relates to wireless network management, and more particularly to a wireless network management method designating a proxy automatically and dynamically.

### (b) Description of the Prior Art

Due to the emergence of the concept Information Appliance, more and more appliances that are simple, convenient, digitized, and Internet connectable appear in households and small-to-medium enterprises. In addition, versatile and heterogeneous connection techniques are co-existent in digital households such as IEEE 802.3, IEEE 802.11, Bluetooth, WiFi, etc.

In these environments, there are a number of issues.

First, Simple Network Management Protocol (SNMP) is the most popular mechanism in a local area network (LAN). But in a large or wide area network, SNMP often leads to congestion.

Secondly, administrator or proxy are outside devices brought into the network.

Thirdly, administrator or proxy cannot provide historical records of a device or some information.

Fourthly, the variation and flow of information is complicated in the LAN and security is difficult to manage.

### SUMMARY OF THE INVENTION

A major objective of the present invention is to automatically designate one of the electronic devices on a local area network (LAN) as a proxy, instead of using an additional dedicated proxy.

Another major objective of the present invention is to share configuration data of the electronic devices so that priorities of the electronic devices to function as the proxy are determined.

To achieve these objectives, the present invention conducts the following steps: electrically connecting a first access device to an electronic device, where the first access device records configuration data of the electronic device, and data-linking the first access device to a local area network (LAN); data-linking a second access device to the LAN, where the second access device accesses and records configuration data of at least another electronic device through the LAN; determining a priority index for each electronic device according to its usage status by a weight calculation module; encrypting data transmitted between the electronic devices by an encryption unit; and comparing the priority indices of the electronic devices and automatically designating the electronic device having the high priority index as a proxy by a proxy designation module. As such, by sharing configuration data and evaluating priorities, one of the electronic devices also functions as the proxy to automatically manage data flow between the electronic devices, thereby avoiding the use of externally added dedicated management devices. The exchanged data may also be encrypted by an encryption unit.

The problems of prior arts when a dedicated administrator or proxy is applied such as traffic congestion, incomplete data exchange, or inferior data security are all resolved by the present invention.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a block diagram showing an embodiment of the present invention.

FIG. 2 is a flow diagram showing the steps of a network management method according to an embodiment of the present invention.

FIG. 3 is a schematic diagram showing an application scenario according to an embodiment of the present invention.

FIG. 4 is another block diagram showing an embodiment of the present invention.

FIG. 5 is yet another block diagram showing an embodiment of the present invention.

FIG. 6 is a schematic diagram showing another application scenario according to an embodiment of the present invention.

FIG. 7 is a schematic diagram showing an application scenario according to another embodiment of the present invention.

FIG. 8 is a schematic diagram showing an application scenario according to yet another embodiment of the present invention.

### DETAILED DESCRIPTION OF THE PREFERRED EMBODIMENTS

The following descriptions are exemplary embodiments only and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

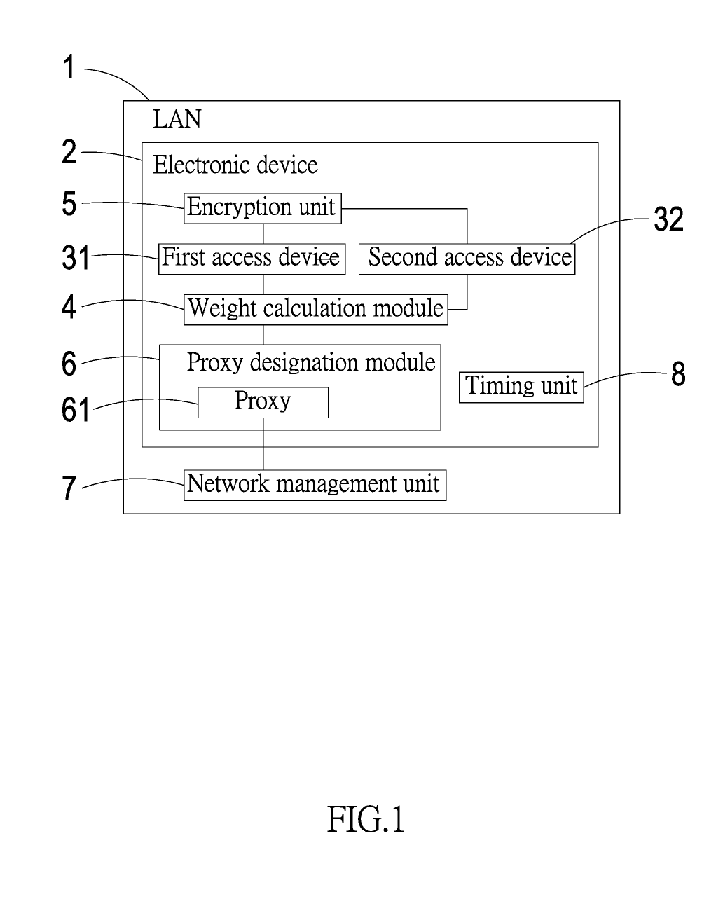

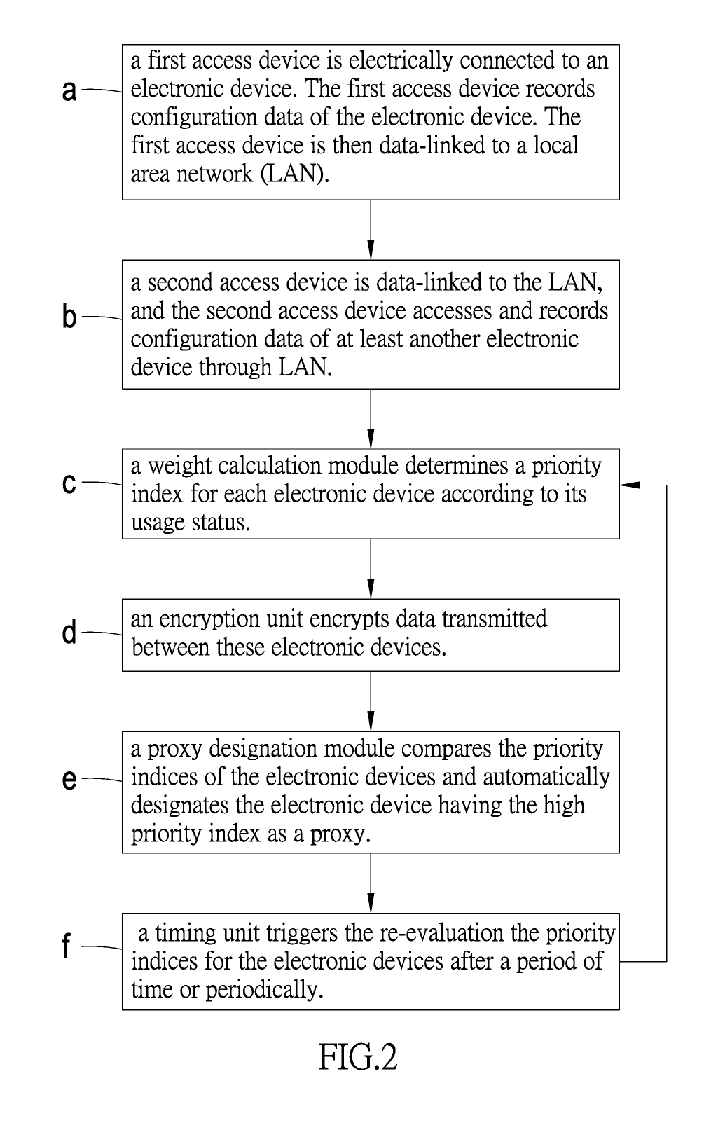

As shown in FIGS. 1 and 2, a wireless network management method according to an embodiment of the present invention includes the following steps:

In step (a), a first access device 31 is electrically connected to an electronic device 2. The first access device 31 records configuration data of the electronic device 2. The first access device is then data-linked to a local area network (LAN) 1.

In step (b), a second access device 32 is data-linked to the LAN 1, and the second access device 32 accesses and records configuration data of at least another electronic device 2 through LAN 1.

In step (c), a weight calculation module 4 determines a priority index for each electronic device 2 according to its usage status.

In step (d), an encryption unit 5 encrypts data transmitted between these electronic devices 2.

In step (e), a proxy designation module 6 compares the priority indices of the electronic devices 2 and automatically designates the electronic device 2 having the high priority index as a proxy 61.

In step (f), a timing unit 8 triggers the re-evaluation the priority indices for the electronic devices 2 after a period of time or periodically.

When an electronic device 2 is designated as the proxy 61, the encryption unit 5 authorizes the proxy 61 to access configuration data stored in the second access device 32. The proxy 61 may be data-linked with a network management unit 7 which is for a user to control the electronic devices 2. The priority index is a reference value obtained from a standard method in evaluating the usage status of an electronic device 2. The usage status includes network connection period, hardware performance, degree of trust, or a combination of these data. The weight calculation module 4 determines the priority index based on these data.

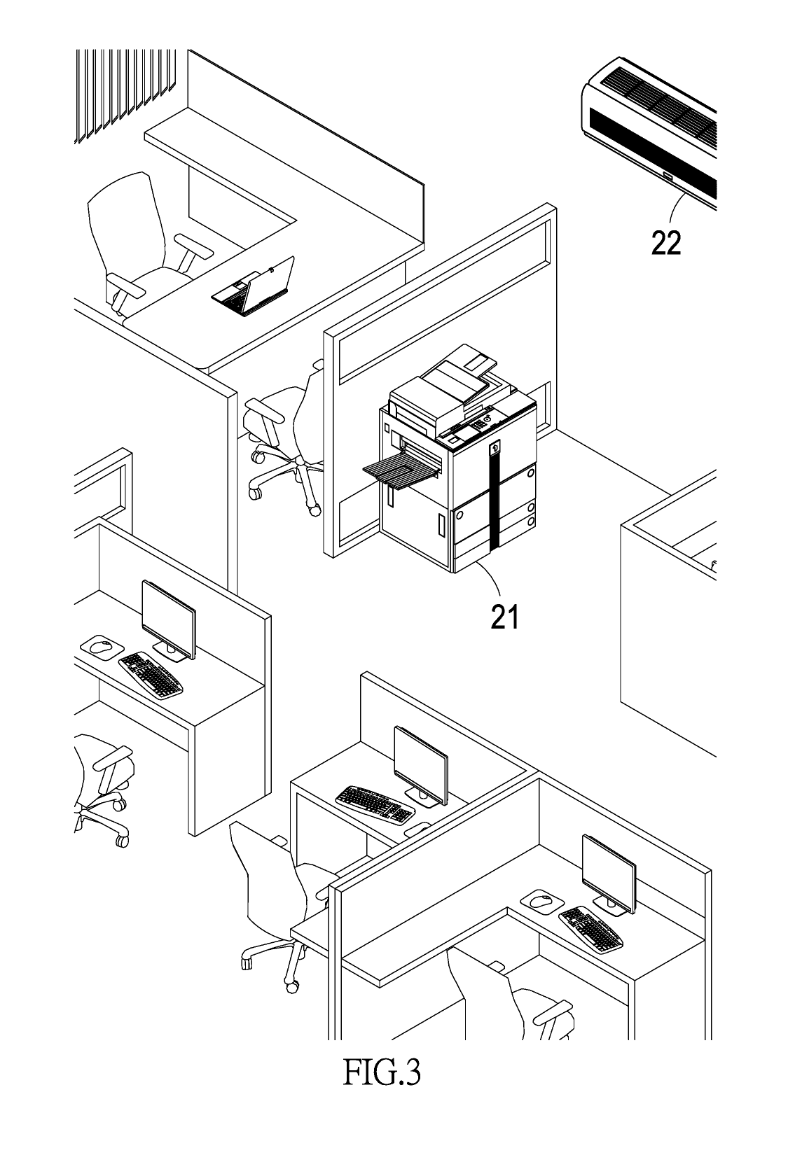

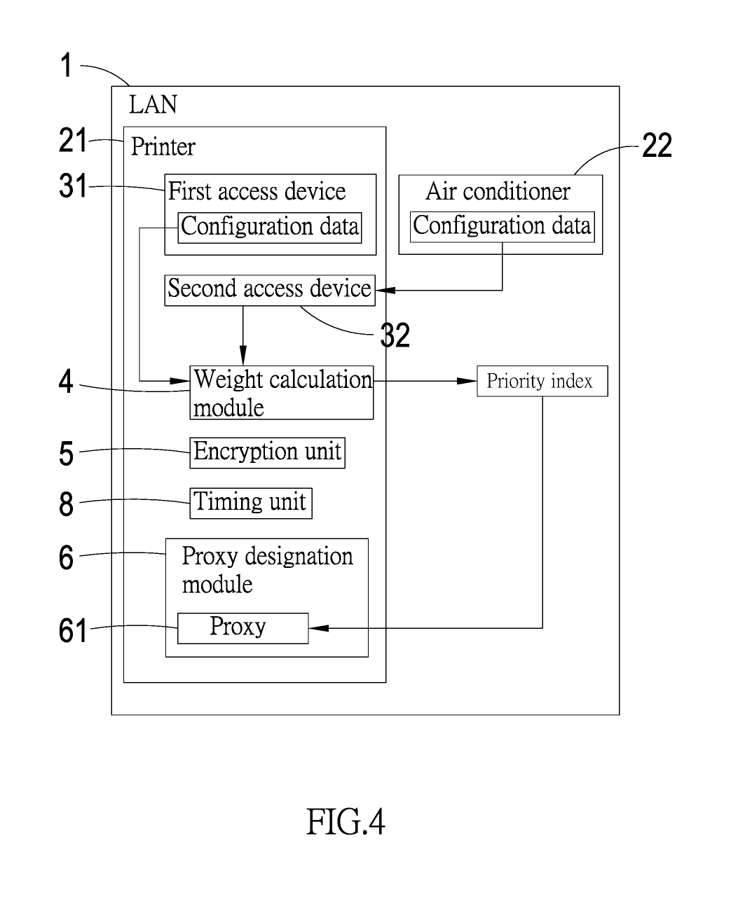

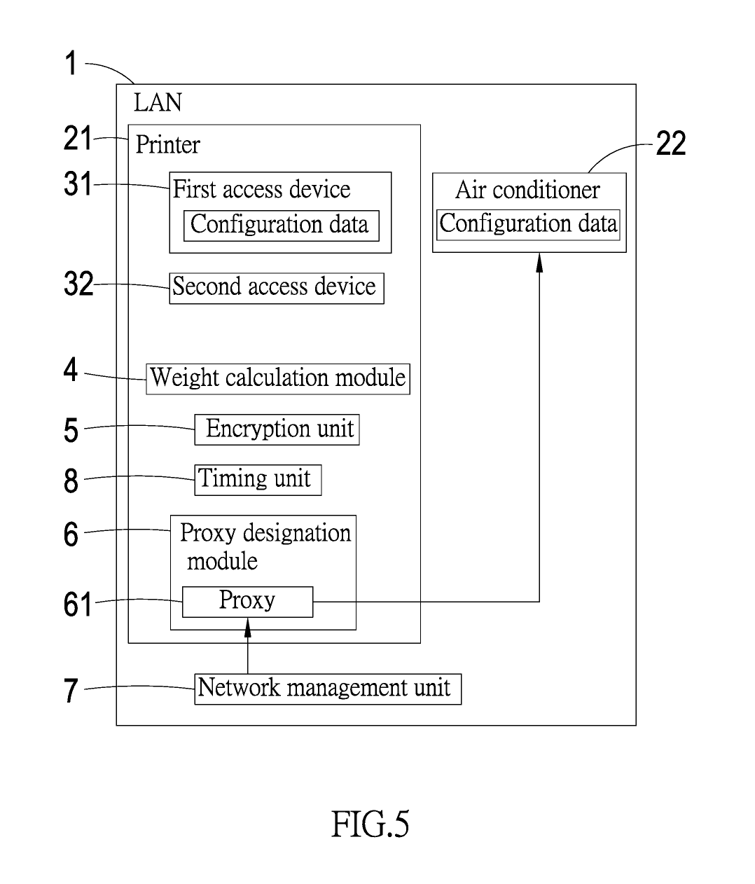

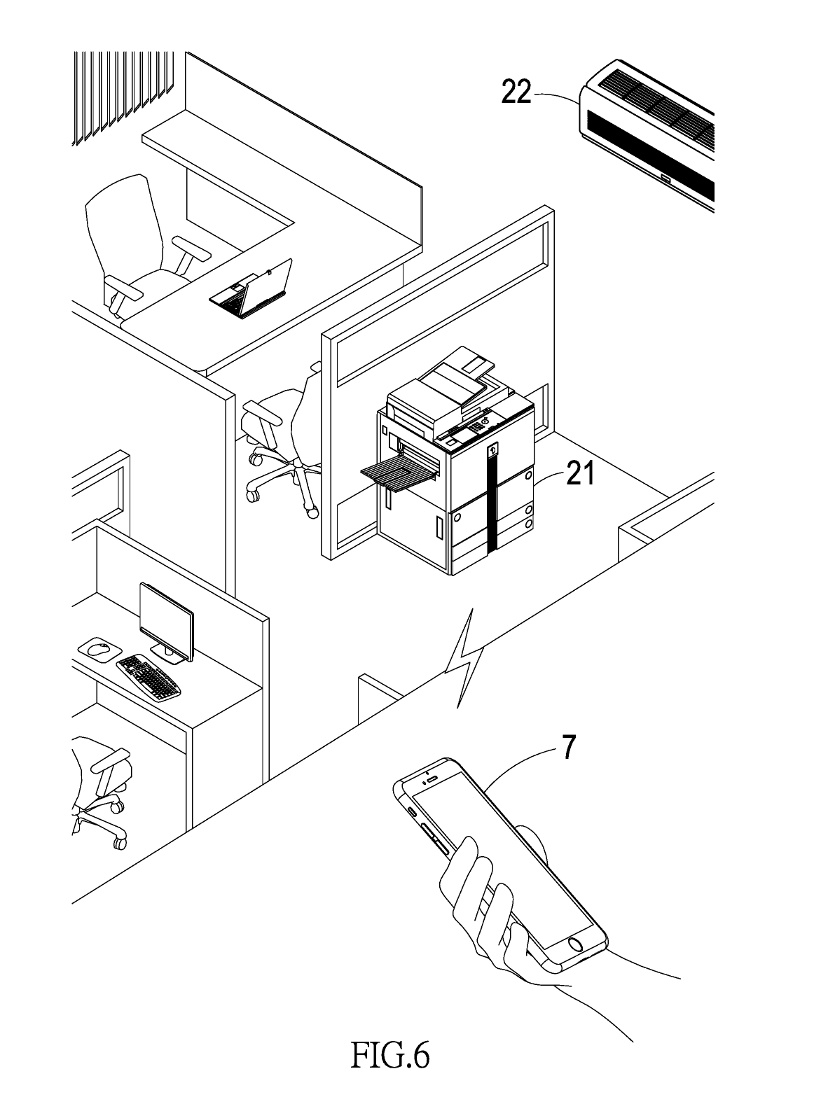

As shown in FIGS. 1 to 6, the electronic devices 2 may be household electronic devices, office electronic devices, or servers. The present embodiment uses office electronic devices as examples such as printer 21 and air conditioner 22, etc. The weight calculation module 4, the encryption unit 5, and the proxy designation module 6 may be software applications, and when they are installed in any one of the electronic devices 2, the network management method of the present invention is implemented. The first and second access devices 31 and 32 may be built-in storage spaces of the electronic devices 2, or they are included in the installed software applications.

Specifically, when various electronic devices 2 are data-linked to a LAN 1, the electronic device 2 (printer 21) stores its configuration data in the first access device 31. The usage status links to the other electronic device 2 (air conditioner 22), accesses and stores its configuration data in the second access device 32. When the above mentioned software applications are installed in multiple electronic devices 2, these electronic devices 2 mutually share their data by accessing the configuration data of each other. The weight calculation module 4 then determines the priority index for each electronic device 2 based on its usage status. The usage status includes network connection period, hardware performance, degree of trust, or a combination of these data. The proxy designation module 6 then compares the priority indices and automatically assign the electronic device 2 having the highest priority index as the proxy 61.

For example, if the printer 21 has a network connection period of 3 hours, and a two-core CPU, and if the air conditioner 22 has a network connection period of 1 hour and a quad-core CPU. The weight calculation module 4 may give different weights to these data such as that the printer 21 has a longer network connection period and therefore has more complete configuration data. The printer 21 is therefore assigned a higher priority index so that the printer 21 is designated as the proxy 61.

After two hours, the air conditioner 22 may also have complete configuration data. The air conditioner 22, due to its higher hardware performance, may be more adequate as the proxy 61. Therefore, the timing unit 8 periodically (such as every one hour) triggers the re-evaluation of the priority indices of the electronic devices 2. In this example, the printer 21 may have a higher priority index in the beginning but the air conditioner 22 may have a higher priority index afterwards.

The electronic device 2 designated as the proxy 61 may automatically monitor, manage, record, and control all data exchanged within the LAN 1. With the encryption unit 5, all data may be encrypted when they are stored in the first and second access devices 31 and 32 for enhanced data security. For example, when a conference room's door is closed, a door control device sends the “door closed” message to a computer host in the hallway designated as the proxy 61. The proxy 61 then automatically turns on the air conditioner in the conference room. A user may also issue commands to the proxy 61, such as inspecting data or performing operation, through the network management unit 7. The network management unit 7 may be a desktop computer, a notebook computer, a smart phone, or a mobile application (APP).

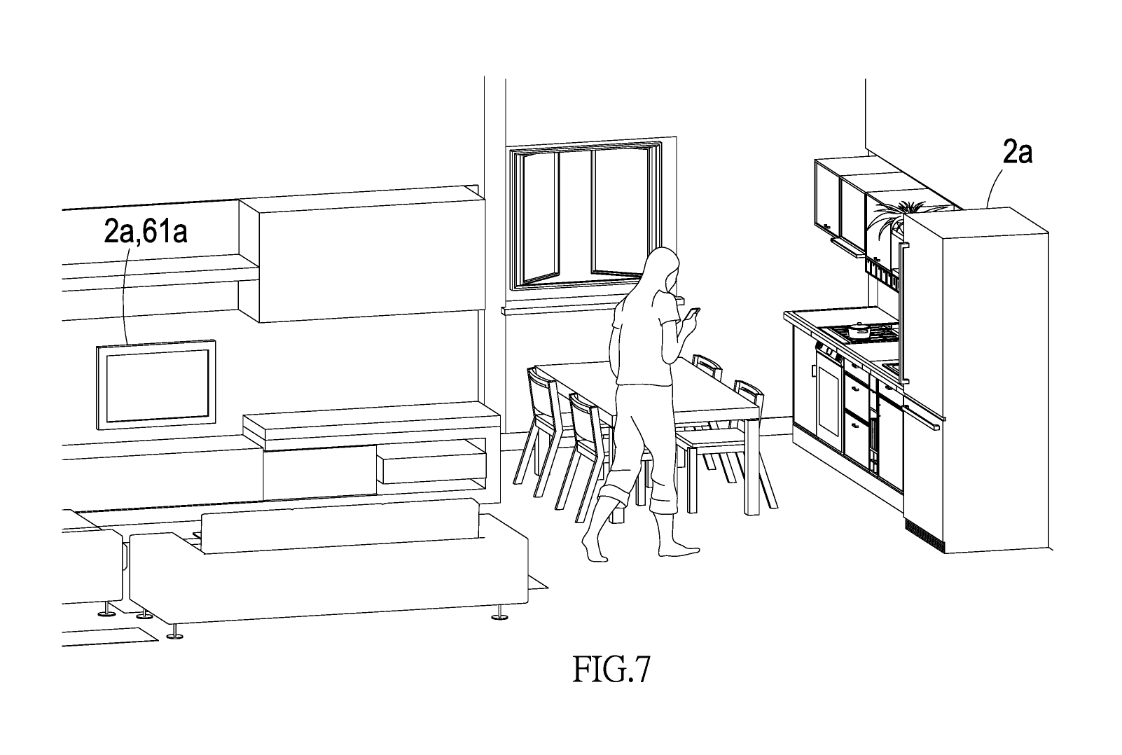

FIG. 7 shows another embodiment where the electronic devices 2a are home electronic appliances. According to another function of the proxy 61a, when a first user connects his mobile phone to the LAN, the proxy 61a learns immediately which electronic device 2a is closest to the mobile phone, and thereby determines the first user's location. A second user may obtain this location data through a network management unit remotely connecting the electronic device 2a functioning as the proxy 61a. When the first user moves with the mobile phone to the vicinity of another electronic device 2a, the electronic device 2a functioning as the proxy 61a, easily determines the movement of the first user and the mobile phone is not required to connect to the LAN again, as the proxy 61a already has the electronic device 2a's configuration data.

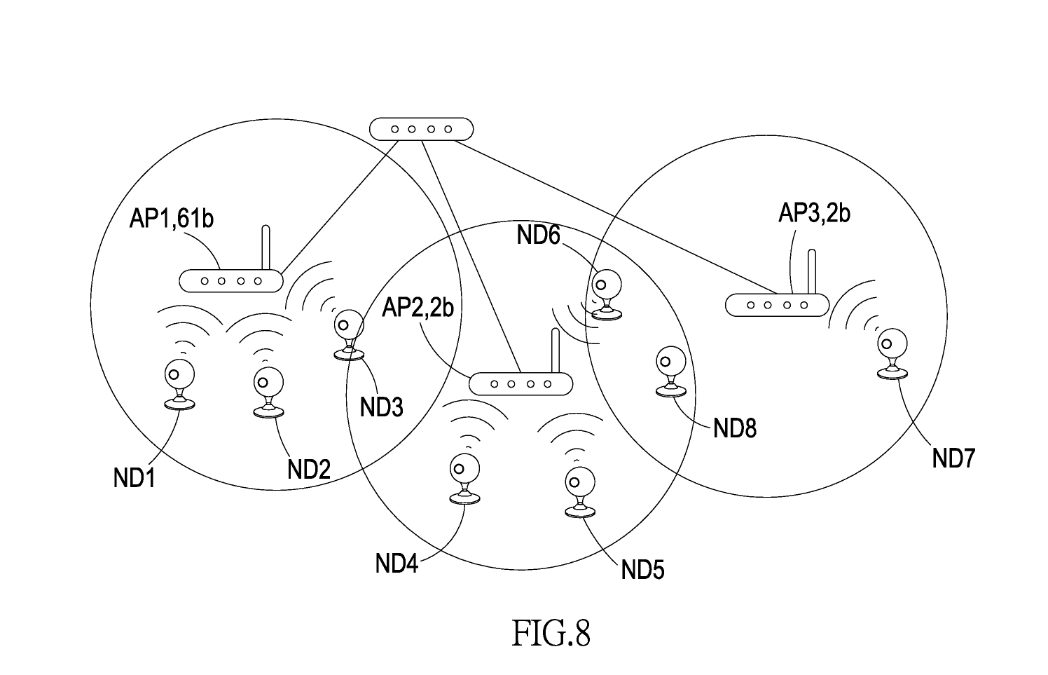

FIG. 8 shows yet another embodiment of the present invention where the electronic devices 2b include Wireless Access Points (WAPs) AP1˜AP3, and network devices ND1˜ND8, which may be network cameras, smart switches, sensor devices, desktop computers, tablet computers, smart phones, etc. The WAP AP1 is assumed to be the proxy 61b.

The network devices ND1˜ND3 are within the coverage of and linked to WAP AP1. The network devices ND4˜ND6 are within the coverage of and linked to WAP AP2. The network device ND7 is within the coverage of and linked to WAP AP3. When the network device ND8 requests services from WAP AP2, WAP AP2 transmits the request and configuration data to WAP AP1 functioning as the proxy 61b and evaluating network resources and statuses. Even though the network device ND8 is at comparable distances to the WAP AP2 and AP3, WAP AP3 is evaluated to have better service bandwidth and therefore better RF signal quality as only one device ND7 is serviced. The proxy 61b then notifies WAP AP2 and AP3 so that network device ND8 connects to WAP AP3.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A wireless network management method, comprising
(a) electrically connecting a first access device to an electronic device, where the first access device records configuration data of the electronic device, and data-linking the first access device to a local area network (LAN);
(b) data-linking a second access device to the LAN, where the second access device accesses and records configuration data of at least another electronic device through the LAN;
(c) determining a priority index for each electronic device according to its usage status by a weight calculation module;
(d) encrypting data transmitted between the electronic devices by an encryption unit; and
(e) comparing the priority indices of the electronic devices and automatically designating the electronic device having the high priority index as a proxy by a proxy designation module.

2. The wireless network management method according to claim 1, wherein, when an electronic device is designated as the proxy, the encryption unit authorizes the proxy to access configuration data stored in the second access device.

3. The wireless network management method according to claim 1, wherein the proxy is data-linked with a network management unit through which a user controls the electronic devices.

4. The wireless network management method according to claim 3, wherein the network management unit is a desktop computer, a notebook computer, a smart phone, or a mobile application (APP).

5. The wireless network management method according to claim 1, wherein the electronic devices may be household electronic devices, office electronic devices, or servers.

6. The wireless network management method according to claim 1, wherein the weight calculation module, the encryption unit, and the proxy designation module are software applications installed in the electronic devices.

7. The wireless network management method according to claim 1, further comprising:
(f) periodically re-evaluating the priority indices for the electronic devices triggered by a timing unit.

8. The wireless network management method according to claim 1, wherein the priority index is a reference value obtained from a standard method in evaluating the usage status of an electronic device.

9. The wireless network management method according to claim 8, wherein the weight calculation module obtains the priority index based on network connection period, hardware performance, degree of trust, or a combination of these data.
